(19) United States
(12) Patent Application Publication
(10) Pub. No.: US 2015/0130189 A1
(43) Pub. Date: May 14, 2015

(54) REGENERATIVE ELECTRICITY SYSTEM FOR ELECTRIC VEHICLES

(71) Applicant: ANGEL AYALA HERMOSILLO, MEXICO CITY (MX)

(72) Inventor: ANGEL AYALA HERMOSILLO, MEXICO CITY (MX)

(21) Appl. No.: 14/076,213

(22) Filed: Nov. 9, 2013

(51) Int. Cl. B60L 11/00; B60L 11/18

(52) U.S. Cl. CPC B60L 11/002; B60L 11/1809; Y10S 74/09; H02K 53/00
USPC 290/45; 74/DIG. 9

(57) ABSTRACT

A regenerative electricity system that can be installed in an electric vehicle to recharge the batteries with the movement of the vehicle while it is driven.

### BACKGROUND

1. Field

The disclosed concept relates generally to a system with a clean technology approach that can be installed in an electric vehicle to recharge the batteries with the movement of the vehicle while it is driven.

2. Background Information

The advantage of an electric vehicle is that it does not produce gas emissions, helping to have cleaner air in cities with too much air pollution, such as, for example, the city of Los Angeles. However, electrical vehicles have several shortcomings. For example, the recharging period of an electric vehicle's batteries is much larger than the period that the vehicle can be actually driven. For most electric vehicles, they can only be used about 30% of the time required to recharge the batteries, which makes them not efficient from an operational standpoint. This is the main reason why gasoline vehicles are still widely used compared to the cleaner, electric vehicles.

Therefore, a system that allows longer trips, for example, a trip from Los Angeles to Miami, would be preferred. In addition, a system adapted to such a vehicle would produce savings to the owner by avoiding the expense linked to recharging batteries from the electric grid. Furthermore, a system that allows an electric vehicle to be a preferred choice over hydrocarbon-based fuels would be preferred.

### SUMMARY

These needs and others are met by embodiments of the disclosed concept which is directed to a system adapted to electrical vehicles that allows it to improve its performance. This system will considerably improve the operation and efficiency of electric vehicles, which currently require stopping the vehicle to recharge the batteries every 50 to 90 miles and waiting for a recharging period of 6 to 8 hours by connecting said vehicle to the electrical grid. In addition, the system of the present invention brings the benefit of increasing the driving period from only 2 to 3 hours in current vehicles to longer trips without needing to recharge, for example a full 24 hour period. Therefore, the electric vehicle will be more efficient and will operate in a more economical manner compared to a current electric vehicle, providing a brand new vehicle without time and/or distance restrictions.

The system of the present invention works as follows: when the electric vehicle starts to move, said movement creates rotation of the tires. When this system is installed, the rotation of the rear tires of the electric vehicle is used to create electricity. Therefore, this system produces regenerative electricity that can be used to recharge the electric vehicle's batteries and/or to send generated electricity back to the electric vehicle's motor so discharging of said batteries is prevented. This is accomplished by installing A/C or D/C generators, depending of the characteristics of the electric motor of said electric vehicle. The generators are connected by flexible shafts to the tires, in such a way that when the tires rotate the shafts transmits the rotation of the tires to the generator. When the vehicle moves the generators will produce said electricity. The speed of the car will generate the electricity required by the electric motor of the vehicle. This means that the higher the driving speed the rotation of the tires is increased, the generators will produce more electricity to match the increased consumption of electricity by the motor of the electric vehicle.

### BRIEF DESCRIPTION OF THE DRAWINGS

A full understanding of the disclosed concept can be gained from the following description of the preferred embodiments when read in conjunction with the accompany drawings in which:

FIG. 1 is a view from above showing the system in accordance with an embodiment of the disclosed concept.

FIG. 2 is a view from above showing the system in accordance with an alternate embodiment of the disclosed concept.

### DESCRIPTION OF THE PREFERRED EMBODIMENTS

For purposes of illustration, embodiments of the invention will be described as applied to electrical vehicles, providing an improvement over electric vehicles which require recharging batteries after a period of driving time typically of 2 to 3 hours. The average electric vehicle recharges its batteries from the electric grid, which produces air pollution from the fuel combustion by the electric plants, which generate electricity for household use. The system of the present invention is designed to eliminate this pollution when installed in an electric vehicle, and to make the average electric vehicle a much better vehicle from an operational standpoint.

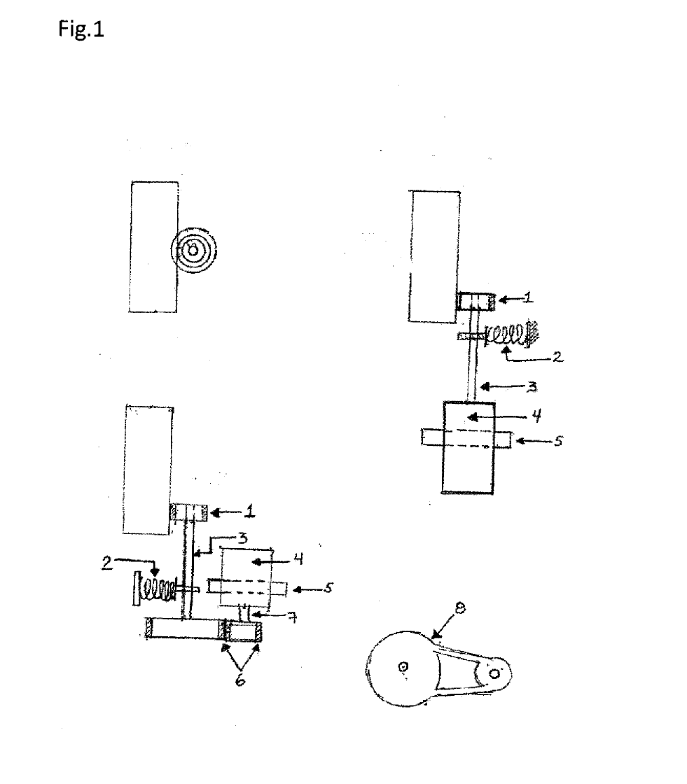

As shown in FIG. 1, the system comprises a small wheel 1, preferred to be about 3 inches in diameter, attached to the front of a flexible shaft 3 that has a connection at the rear end to the shaft of an alternator or DC generator 4, depending on the type of electric motor, direct current or alternate current, installed in the vehicle. The design of the alternator or DC generator 4 preferably will be a low rpm, high current output at low speed to be able to cope with the voltage and current requirements of the electric motor installed in the vehicle. The small wheel 1 should be in close contact with the inside face of the rear tires of said vehicle, in such a way that when the vehicle starts moving, the rear tires rotate and therefore create the rotation of the small wheel 1 that is in close contact with the rear tires of the vehicle. The rotation of said small wheel 1 will generate rotation of the shaft 3 of the alternator or generator 4 that is connected at the rear end of the shaft. When the shaft starts to rotate the alternator or generator 4 will produce electric current as a result of the rotation created by the flexible shaft 3.

Inside the small wheel 1 is a ratchet mechanism connected to the flexible shaft 3 that only allows rotation of said shaft when the vehicle moves forward. When the vehicle moves in reverse, there will not be shaft rotation. To keep the small wheel 1 in close contact with the vehicle's tire, the shaft 3 should be installed at a small angle to force the small wheel 1 to be pressed against the inside face of the tire. In an alternate embodiment, a spring loaded mechanism 2 can be installed to create the same effect. It is noted that any upward or downward movement of the tire as a result of a bump or a hole in the road will not affect the performance because the small wheel 1 will slip along the face of the tire. Also, in case there is the need to change the rear tire, the small wheel 1, attached to the flexible shaft 3 will be reset to its original place with the help of the spring loaded mechanism 2 provided. In an alternate embodiment, the spring loaded mechanism 2 can be replaced with a solenoid connected to a switch accessible to the driver of the vehicle, so the driver may stop the generator or alternator 4 when the batteries are fully charged. The solenoid will perform the same function of the spring loaded mechanism 2.

The electricity generated by the alternator or generator 4, will be used to charge the batteries of the vehicle while the vehicle is in motion. This system has the advantage of not consuming electricity from the batteries when the vehicle is in operation. On the contrary, the electricity generated by the alternator or the generator 4 will be used to charge the batteries of the vehicle while the vehicle is in motion. This means that the electricity produced by the system can be used to improve the performance of the electric vehicle.

The selection of the components of the system will be related to the electric motor installed in the vehicle, and the type and amount of batteries used, since different voltages for the electric motor are used, depending on the brand of the vehicle, for example, 72 volts, 96 volts, etc. As an important fact, there is no need to use higher voltages in the electric motor due to the fact that with this system one is not limited to the amount of amperes that the batteries must supply, therefore there is no need to increase the voltage to improve the distance to be driven by the electric vehicle. This helps to select the most economic alternator or generator needed to match the voltage of the motor. Most alternators come with a full wave rectifier installed. If not, a full wave rectifier can be installed to charge the batteries of the vehicle so the batteries can be recharged with direct current.

The small wheel 1 may vary in diameter depending on the size of the vehicle tires, the bigger the diameter of the tire in the vehicle, the increased rotation of the small wheel 1 and thus more rpm of the small wheel 1 attached to the shaft 3 of the generator or alternator 4 to increase the rotation speed of the generator or alternator 4 and as a result the increased voltage and or amperes to match the requirements of the electric motor on the vehicle.

The small wheel 1, preferred to be 3 inches in diameter, has a ring made of rubber or other material with high friction coefficient to prevent slippage between the tire of the vehicle and to improve contact of the small wheel 1 of the system.

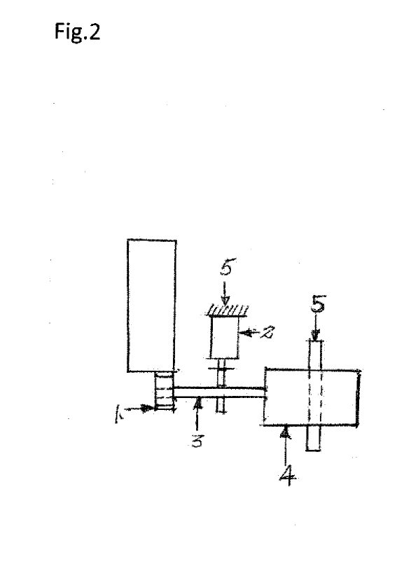

In case it is necessary to increase the rotation of the shaft 3 attached to the alternator or generator 4, it would be convenient to install an rpm amplifier to match the requirements of the motor. To increase the turns of the shaft 3 it may be necessary to install an additional wheel, preferably 8 inches in diameter, at the end of the shaft instead of the generator or alternator 4. To the right of this additional large wheel, in very close contact, an additional or second small wheel 6, which preferably is also 3 inches in diameter as the small wheel 1, can be installed attached to a second flexible shaft 7 that will connect with the alternator or generator shaft at the rear end. The rotation of the additional wheel will produce an increased amount of turns of the second small wheel 6 that will increase the rpm of the shaft of the generator or alternator attached at the end of the second shaft, to increase the output of the alternator or generator 4 to be able to meet the electric motor requirements. The set of the additional wheel and the second small wheel 6 can be seen as 8 in FIG. 2. These wheels can have alternative embodiments that can be used such as gears, or pulleys, or belts or even two hydraulic impellers mounted on a sealed case that will produce the same rotation as this set of wheels 8

An additional alternative of the system can be seen in the drawing in FIG. 2, which is a more straightforward design. That is, the small wheel 1 is positioned in close contact to the front face of the tire, that is ,the face of the tire that makes contact with the road that produces the vehicle movement. In this case the shaft is a straight shaft and connects the small wheel 1 to the generator, having in between a solenoid with a switch that can be placed near the driver so that the driver can disconnect the alternator or generator direct current or alternate current 4 when the batteries are fully charged, as shown in FIG. 2.

It will be appreciated by those skilled in the art that the described system refers to one rear tire of the vehicle, but if necessary to increase the output of the system, a second unit can be installed in the opposite rear tire of the vehicle to double the output of the system and match the requirements of the electric motor of the vehicle.

1. A regenerative electricity system for electric vehicles, which uses the movement of said electric vehicle to produce electricity while said electric vehicle is being driven, comprising
a small wheel in close contact to the face of the rear tire of the electric vehicle;
a flexible shaft attached to said small wheel;
a generator connected to said flexible shaft;
wherein the rotation of the electric vehicle's tire will produce rotation of the small wheel, which in turn will produce rotation of the flexible shaft,
wherein electric current is produced by said generator as result of the rotation of said flexible shaft;
wherein the electricity produced by said regenerative electricity system can be used to charge the batteries of an electric vehicle or to forward said generated electricity directly to the electric motor to increase the time and the distance that the vehicle can be driven.

2. A regenerative electricity system for electric vehicles of claim 1, wherein said small wheel is 3 inches in diameter.

3. A regenerative electricity system for electric vehicles of claim 1, wherein said generator is an alternator.

4. A regenerative electricity system for electric vehicles of claim 1, wherein said generator is a DC generator.

5. A regenerative electricity system for electric vehicles, which uses the movement of said electric vehicle to produce electricity while said electric vehicle is being driven, comprising
a first small wheel in close contact to the face of the rear tire of the electric vehicle;
a first flexible shaft attached to said first small wheel;
a large wheel attached to said flexible shaft;
a second small wheel placed on a side of said large wheel;
a second flexible shaft attached to said second small wheel;
a generator connected to said second small wheel;
wherein the rotation of the electric vehicle's tire will produce rotation of the first small wheel, which in turn will produce rotation of the flexible shaft,
wherein the rotation of said flexible shaft produces rotation of the large wheel, which in turn produces rotation of said second small wheel at increased speed, thus providing rotation of said second flexible shaft at increased speed;
wherein electric current is produced by said generator as result of the rotation of said second flexible shaft;
wherein the electricity produced by said regenerative electricity system can be used to charge the batteries of an electric vehicle or to forward said generated electricity directly to the electric motor to increase the time and the distance that the vehicle can be driven.

6. A regenerative electricity system for electric vehicles of claim 5, wherein said first and second small wheels are 3 inches in diameter.

7. A regenerative electricity system for electric vehicles of claim 5, wherein said large wheel is 8 inches in diameter.

8. A regenerative electricity system for electric vehicles of claim 5, wherein said generator is an alternator.

9. A regenerative electricity system for electric vehicles of claim 5, wherein said generator is a DC generator.
